(19) United States
(12) Patent Application Publication
(10) Pub. No.: US 2013/0271571 A1
(43) Pub. Date: Oct. 17, 2013

(54) Method and Arrangement for Processing of Encoded Video

(71) Applicants: Zhuangfei Wu, Danderyd (SE); Thomas Rusert, Kista (SE)

(72) Inventors: Zhuangfei Wu, Danderyd (SE); Thomas Rusert, Kista (SE)

(73) Assignee: TELEFONAKTIEBOLAGET L M ERICSSON (PUBL), Stockholm (SE)

(21) Appl. No.: 13/996,280

(22) PCT Filed: Dec. 27, 2010
(86) PCT No.: PCT/SE10/51485

§ 371 Date: Jun. 20, 2013

(51) Int. Cl. H04N 13/00

(52) U.S. Cl. CPC H04N 13/0048
USPC 348/43

(57) ABSTRACT

Methods and arrangements in video handling entities for transforming an MVC bit stream to an AVC bit stream and vice versa. The methods and arrangements involve modification of reference data in an obtained bit stream and thus transforming the bit stream into another format. The suggested solution is a low complexity procedure, and thus much faster than e.g. transcoding of a bit stream into another format.

### TECHNICAL FIELD

The invention relates to 3D video coding, and especially to the use of encoders and decoders having different characteristics.

### BACKGROUND

H.264/AVC (Advanced Video Coding) [1] is the state of the art video coding standard. An H.264/AVC codec eliminates redundancy information within and/or between frames. The standard comprises multiple hybrid video coding techniques, such as e.g. motion compensation and entropy coding. These techniques contribute to the high coding efficiency of H.264/AVC. After coding by use of an H.264/AVC encoder, the coded bit stream, called VCL (Video Coding Layer), is further encapsulated into NAL (Network Abstraction Layer) packets. In the H.264/AVC standard, several profiles are defined, which relate to the operating point of an encoder and/or decoder. Among these profiles are the “baseline profile”, “extended profile”, “main profile” and “high profile”, which are “traditional” 2D video coding modes. Those “traditional” profiles are commonly referred to as “AVC”. Additionally, H.264/AVC has so-called “scalable” profiles, including the “scalable baseline profile” and “scalable high profile”. Those are commonly referred to as “SVC” (Scalable Video Coding). Additionally, H.264/AVC has so-called “multi-view” profiles, including the “stereo high profile” and the “multi-view high profile”. Those multi-view profiles are referred to as “MVC” (Multi-view Video Coding).

AVC supports coding of 3D stereo video using so-called “frame packing arrangements”, where the “left” and “right” stereo video streams are coded into a single 2D video stream. Such arrangements can be signaled by means of the “frame packing arrangement SEI message” [1]. “Frame packing” arrangements are typically used in today's first 3D broadcast deployments, since they allow the re-use of existing 2D infrastructure and Set-Top Boxes (STBs).

Besides mono view sequence, there are also multi-view sequences, which are recorded by multiple cameras from different angles. A simple yet common example of a multi-view sequence is a sequence with two views from slightly different angles, which is also referred to as “stereo video”. Stereo video, also commonly referred to as “3D video”, is a major trend in cinemas and is used increasingly in home environments. MVC is a video coding standard that efficiently eliminates the redundancy information, not only within one view, but also between views. MVC is based on the AVC standard, and is included in the later editions of AVC [1]. The MVC bit stream syntax and semantics have been kept similar to the AVC bit stream syntax and semantics.

The “MVC stereo high profile” is specified for use on “3D stereo” Blu-Ray disks, and may be used in future broadcast deployments. However, no such deployments exist as of today.

AVC is a very successful video coding standard which has been widely deployed among TVs, STBs, PCs and mobile devices around the world. MVC was not established until several years after AVC had been accomplished. Hence, not as many MVC decoders can be found in the market or in service today, as compared to the number of AVC decoders. This is the reason why today's 3D broadcasts use “frame packing arrangements”, i.e. AVC (2D) compatible coding. However, since 3D video is an increasingly hot technical area, there will potentially be great demands for MVC applications, and thus more MVC content can be expected to be available in the future. As of today, the first Blu-Ray discs with “stereo high profile” content can be found in the market.

However, conventional AVC decoders, e.g. in legacy equipment, are not capable of decoding multi-view MVC content. It has thus been identified as a problem that MVC content cannot be utilized or displayed in 3D by devices only capable of AVC decoding.

### SUMMARY

It would be desirable to enable decoding of MVC content by use of AVC decoders. It is an object of the invention to enable decoding of MVC content by use of AVC decoders. Further, it is an object of the invention to provide a method and an arrangement for enabling decoding of MVC content by use of AVC decoders. These objects may be met by a method and arrangement according to the attached independent claims. Optional embodiments are defined by the dependent claims.

In this document, a light weight transformation method from MVC to AVC is disclosed. Further, a light weight transformation method from AVC to MVC is disclosed. An MVC to AVC transformer could advantageously be placed in between an MVC encoder and an AVC decoder, thus enabling an MVC bit stream to be properly decoded by an AVC decoder. Correspondingly, an AVC to MVC transformer could advantageously be placed in between an AVC encoder and an MVC decoder, thus enabling a multi-view AVC bit stream to be properly decoded by an MVC decoder. The transforming procedures described below may be performed e.g. within a video encoding entity after the respective AVC or MVC encoding, in a video decoding entity, or in an intermediate video handling entity.

This solution bridges the current barrier between MVC and AVC and thus in principle provides for the possibility to allow 3D application on top of AVC. Considering the great similarity between AVC and MVC, throwing away MVC related content is a waste of bandwidth. This may be avoided by use of the solution suggested in this document.

According to a first aspect, a method for transformation of a bit stream from MVC to AVC is provided in a video handling entity. The method comprises obtaining an MVC bit stream comprising multiple views, and identifying reference information, such as e.g. slice header information, in the MVC bit stream. The method further comprises modifying the reference information, such that the MVC bit stream is transformed into an AVC bit stream, also comprising multiple views (at least two), i.e. all of, or a subset of, the views comprised in the MVC bit stream. The transformation enables that at least two of (all of, or a subset of) the views comprised in the AVC bit stream can be decoded by use of an AVC decoder.

According to a second aspect, an arrangement is provided in a video handling entity. The arrangement comprises a functional unit, which is adapted to obtain an MVC bit stream comprising multiple views. The arrangement further comprises a functional unit, which is adapted to identify reference information in the obtained MVC bit stream. The arrangement further comprises a functional unit, which is adapted to modify the reference information, such that the MVC bit stream is transformed into an AVC bit stream comprising multiple views, thereby enabling at least two of said views comprised in the AVC bit stream to be decoded by use of an AVC decoder.

According to a third aspect, a method is provided for transformation of a bit stream from AVC to MVC in a video handling entity. The method comprises obtaining an AVC bit stream comprising multiple views, and identifying reference information in the AVC bit stream. The method further comprises determining whether the prediction structure of the AVC bit stream can be applied to MVC. The method further comprises modifying the reference information, such that the AVC bit stream is transformed into an MVC bit stream comprising multiple views, when it is determined that the prediction structure of the AVC bit stream can be applied to MVC. The transformation enables at least two of said views comprised in the MVC bit stream to be decoded by use of an MVC decoder.

According to a fourth aspect, an arrangement is provided in a video handling entity. The arrangement comprises a functional unit, which is adapted to obtain an AVC bit stream comprising multiple views. The arrangement further comprises a functional unit, which is adapted to identify reference information in the obtained AVC bit stream. The arrangement further comprises a functional unit, which is adapted to determine whether the prediction structure of the AVC bit stream can be applied to MVC. The arrangement further comprises a functional unit, which is adapted to modify the reference information, such that the AVC bit stream is transformed into an MVC bit stream comprising multiple views, when the prediction structure of the AVC bit stream can be applied to MVC. The transformation enables at least two of said views comprised in the MVC bit stream to be decoded by use of an MVC decoder.

The above methods and arrangements may be implemented in different embodiments. Examples of modifications which may be performed when transforming an MVC bit stream into an AVC bit stream are: changing NAL unit type, removing NAL header MVC extension, changing the order of reference picture indicators in a reference picture list, changing the order of appearance of NAL units in the bit stream, removing prefix NAL units, removing Subset Sequence Parameter Sets, changing the Sequence Parameter Set (SPS), changing the Picture Order Count (POC) syntax element in the slice header, adding AVC frame packing arrangement Supplemental Enhancement Information (SEI) messages, and/or adding signaling regarding frame arrangement per view.

Examples of modifications which may be performed when transforming an AVC bit stream into an MVC bit stream are: changing the NAL unit type, changing the order of reference picture indicators in a reference picture list, changing the reference picture list index associated with a reference picture, changing the order of appearance of NAL units in the bit stream, adding prefix NAL units to base layer, adding subset SPSs, changing the SPS, changing the POC syntax element in the slice header, removing AVC frame packing arrangement SEI messages and/or removing signaling regarding frame arrangement per view.

According to yet another aspect, a computer program is provided, which comprises computer readable code means, which when executed in one or more processing units, causes any of the arrangements described above to perform the corresponding procedure according to one of the methods described above.

According to yet another aspect, a computer program product is provided, which comprises the computer program of above.

### BRIEF DESCRIPTION OF THE DRAWINGS

The invention will now be described in more detail by means of exemplary embodiments and with reference to the accompanying drawings, in which:

FIGS. 1-2 are schematic views illustrating MVC encoded multi-view 3D video, according to the prior art.

FIG. 3 is a schematic view illustrating the allocation of base layer and enhancement layer in an MVC bit stream, according to the prior art.

FIG. 4 illustrates decoding of an MVC bit stream by use of an AVC decoder, according to the prior art.

FIG. 5 is a schematic view illustrating the transformation of an MVC bit stream into an AVC bit stream, according to an exemplifying embodiment.

FIG. 6 is a schematic view illustrating the transformation and decoding of a bit stream, according to an exemplifying embodiment

FIG. 7 is a schematic view illustrating the construction of reference picture lists in MVC and AVC, and the modification of the AVC reference picture list, according to an exemplifying embodiment.

FIG. 8 is a flow chart illustrating a procedure transformation of a bit stream from MVC to AVC in a video handling entity, according to an exemplifying embodiment.

FIG. 9 is a block diagram illustrating an arrangement adapted for transformation of a bit stream from MVC to AVC in a video handling entity, according to an exemplifying embodiment.

FIG. 10 is a flow chart illustrating a procedure transformation of a bit stream from AVC to MVC in a video handling entity, according to an exemplifying embodiment.

FIG. 11 is a block diagram illustrating an arrangement adapted for transformation of a bit stream from AVC to MVC in a video handling entity, according to an exemplifying embodiment.

FIG. 12 is a schematic view illustrating an arrangement in a video handling entity, according to an embodiment.

### DETAILED DESCRIPTION

MVC is designed in a backward compatible manner, which implies that a base layer AVC bit stream could be extracted from an MVC bit stream by an AVC decoder. However, the higher layer bit stream, i.e. representing views other than the base view, would be discarded, leaving only a mono view being decoded and displayed. Consequently, if a TV service provider was to start sending MVC content today, most of the clients' decoders would simply discard most of the MVC bit stream, since the clients' AVC decoders “do not understand” parts of an MVC bit stream. Thus, the clients having AVC decoders would not be able to make use of the MVC content, and much data has been communicated and processed in vain.

These “AVC clients” could replace their AVC decoder by an MVC decoder in order to be able to decode an MVC bit stream. However, it would involve great costs if all AVC codecs were to be replaced by MVC codecs.

An alternative to replacing the decoders could be to transcode MVC stereo video into AVC video with frame packing arrangement SEI, e.g. before providing it to the clients. A transcoding operation would involve decoding of the MVC video using an MVC decoder, and then re-encoding the video using an AVC encoder and frame-packing arrangement SEI. Since complete decoding and encoding procedures are involved, this would be a very complex and time-consuming operation.

MVC and AVC share almost the same base, e.g. NAL, motion compensation, entropy coding, and so forth. The only major difference is the prediction structure. It is realized that these similarities may provide a possibility to build a bridge to connect between MVC and AVC. In this document, a method for modifying an MVC bit stream in a way such that a single AVC decoder can recognize and perform consequent appropriate decoding of both the base view and other views comprised in the stream, will be described. Further, a method for modifying an AVC bit stream with frame packing SEI into a bit stream which can be properly decoded by an MVC decoder, will be described.

### MVC to AVC

The basic concept is to perform light weight modifications and/or insertions, e.g. on the slice header level, while maintaining the rest of the bit stream. That is, it is not a question of decoding the bit stream and then re-encoding it using another encoder. The encoded video will remain encoded during the transformation. The modification could involve a reference picture marking process and a reference picture list modification process. Further, some specific MVC to AVC bit stream “stripping” process could be performed, such as e.g. deletion of prefix NAL units and NAL header MVC extensions.

MVC-encoded video comprises a base layer and one or more enhancement layers. Each layer represents an encoded view, or stream, of 3D video. The different layers comprise NAL units of different predefined NAL Unit Types (NUTs). The different NUTs are defined in the AVC and MVC standards.

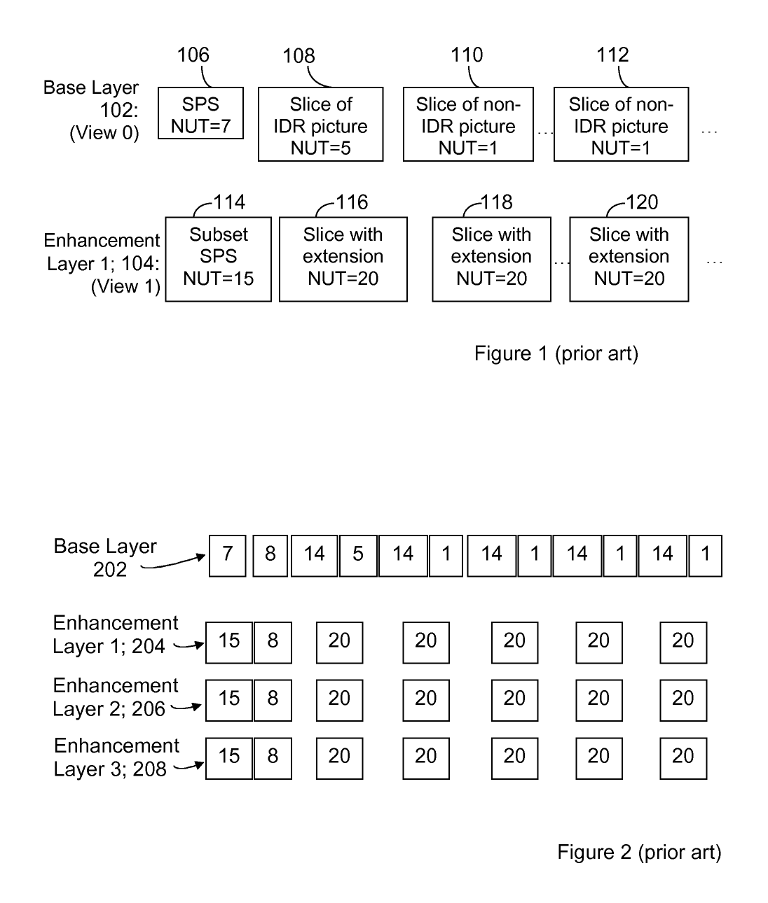

FIG. 1 is a schematic view showing a sequence of NAL units of a base layer 102 and a first enhancement layer 104 of MVC encoded video. Here, the base layer 102 comprises e.g. NAL unit 106 of NUT 7, which implies that the NAL unit 106 comprises the SPS. Further, the base layer comprises NAL unit 108 of NUT 5, which implies that NAL unit 108 comprises a slice of, i.e. the whole or a part of, an Instantaneous Decoder Refresh (IDR) picture, which may be decoded without using reference pictures. The base layer further comprises NAL units 110 and 112, being of NUT 1, which implies that the respective NAL units 110 and 112 comprise a slice of a non-IDR picture i.e. a slice of a picture which should be decoded using one or more reference pictures. The enhancement layer 104 in FIG. 1 comprises e.g. NAL unit 114 of NUT 15, comprising the Subset SPS, and NAL units 116-120 of NUT 20, comprising slices of non-IDR pictures.

FIG. 2 illustrates a slightly longer exemplifying sequence of MVC encoded 3D video than FIG. 1. The MVC sequence in FIG. 2 comprises a base layer 202 and three enhancement layers, 204-208. In the example shown in FIG. 2, it can be seen that the NAL unit structure differs between the base layer and the enhancement layers, but is similar between the enhancement layers. This example, as compared to the example in FIG. 1, further comprises NAL units of NUT 8, which comprises the Picture Parameter Set (PPS), and so-called “prefix NAL units” of NUT 14.

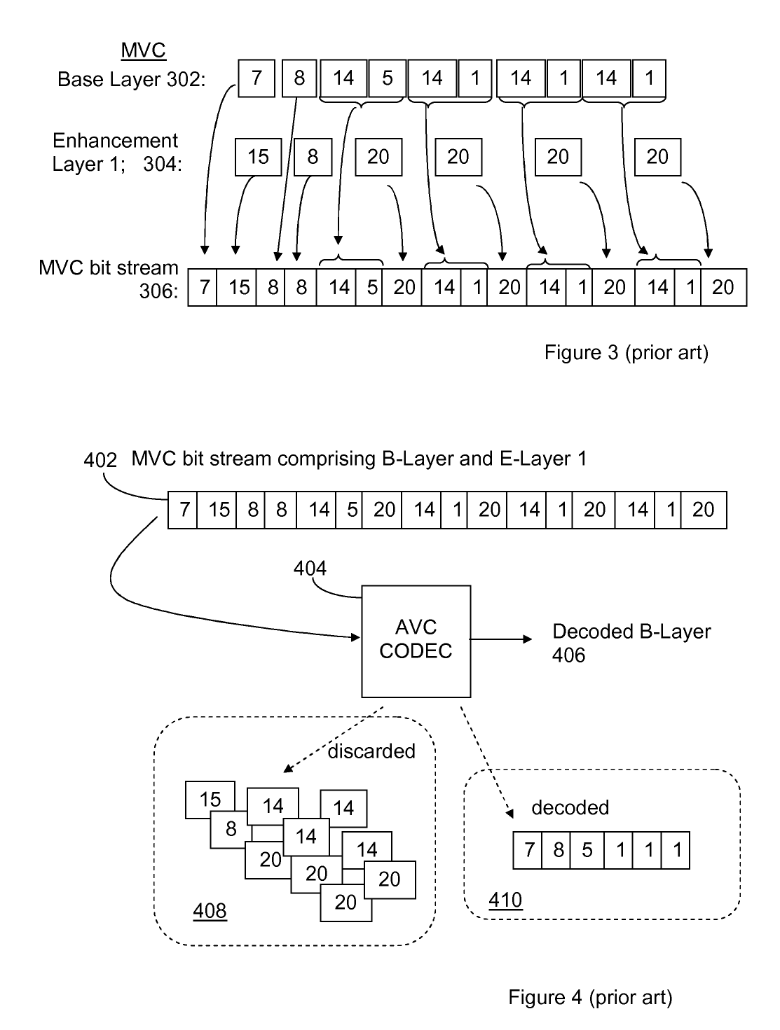

The base layer and the enhancement layer(s) are merged together, e.g. interleaved, in the MVC bit stream. An example of how the different layers are allocated in the MVC bit stream is illustrated in FIG. 3, which shows a base layer 302 and a first enhancement layer 304. The arrows indicate how the NAL units from the different layers are placed in the MVC bit stream 306. NAL units from any further enhancement layer(s) would be inserted in a corresponding manner.

Within this document, a “bit stream” is illustrated at NAL unit level, i.e. as a sequence of NAL units, for reasons of clarity and intelligibility for the reader.

The decoding of an MVC bit stream 402 by use of an AVC decoder 404 is illustrated in FIG. 4. The MVC bit stream is fed to the AVC codec 404, which after decoding outputs the decoded base layer 406 of the MVC bit stream, i.e. the base view (2D). The NAL units associated with the enhancement layers of the MVC bit stream are discarded or ignored by the AVC codec 404. The discarding of non-base layer NAL units is illustrated in the area 408, having a dashed outline. The NAL units, which are actually decoded by the AVC codec 404, are the remaining NAL units, i.e. the NAL units which are familiar to an AVC decoder. The NAL units which are decoded by the AVC codec are illustrated in the area 410, having a dashed outline.

### MVC Bit Stream Adaptation

In order to make more than one of the views comprised in an MVC bit stream decodable by use of an AVC decoder, some MVC specific content should be modified and/or removed. Further, in order to enable “proper” display of the modified bit stream after decoding, reference picture modifications may be needed. The process of modifying an MVC bit stream to become decodable by an AVC decoder will be described below.

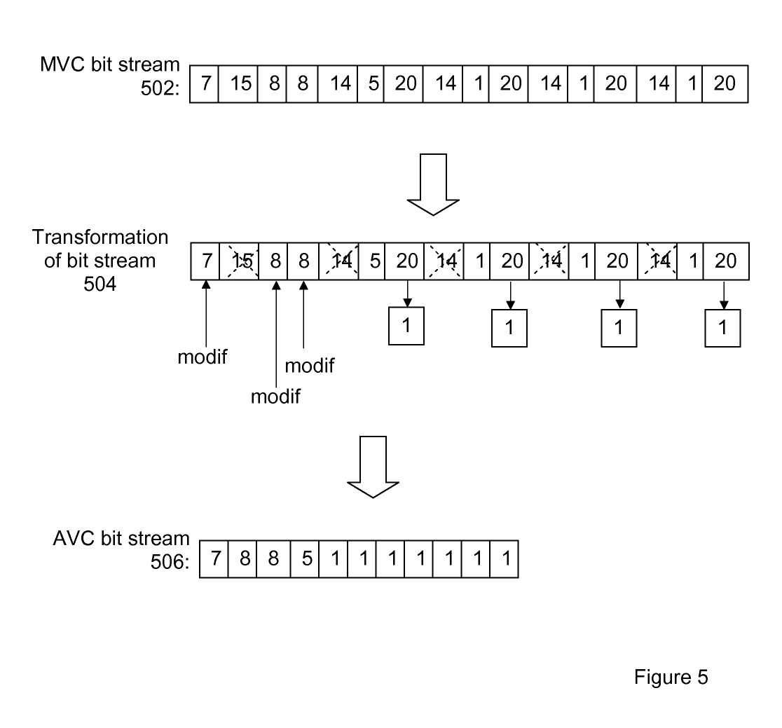

FIG. 5 illustrates an example where an MVC bit stream 502, comprising two views/streams of (3D) video encoded as a base layer and a first enhancement layer, is modified into an AVC bit stream 506 comprising the two view/streams of video. The “intermediate” bit stream 504 is added to FIG. 5 in order to facilitate the understanding of different possible components of the modification procedure. In the stream 504, the NAL unit of NUT 15, i.e. the Subset SPS, and the NAL units of NUT 14, i.e. the prefix NAL units, are removed, which is illustrated by a dashed cross over these NAL units. These X-ed NAL units could alternatively remain in the bit stream, since NUTs which are not recognized by an AVC decoder will be discarded by said decoder. Further, the NAL unit header MVC extension is deleted in the NAL units of NUT 20, and the NUT of these units are further changed to NUT 1, since NUT 20 is associated with the enhancement layer, and thus not being recognizable to an AVC decoder. However, the content of the NAL units of which the NUT is changed, i.e. slices of non-IDR pictures, remains unmodified. Further, the NAL units of NUT 7 and 8 may be modified to correspond to the created AVC bit stream. This will be further described below.

A NAL unit of NUT 7 comprises an SPS. When modifying an MVC bit stream to an AVC bit stream, the parameter “Profile_idc” in the SPS may be changed to the corresponding AVC configuration. The parameter “Profile_idc” is related to the syntax and methods used in the VCL. It may further be necessary and/or desired to change the value of the parameter “level_idc” in the SPS. The parameter “level_idc” is related to the memory and processing capabilities required to decode a bit stream, e.g. the number of blocks or frames to be decoded per second.

A NAL unit of NUT 8 comprises a PPS. The PPS is activated by a PPS_id field in the Slice header. The SPS (NUT 7) is activated by a SPS_id field in an activated PPS. Since a SPS_id may be changed, the PPS may need to be changed in accordance e.g. with such a change of SPS_id.

Since multiple views comprised in an MVC bit stream are to be combined into a common AVC bit stream, the processing power required at the AVC decoder side may be greatly increased, as compared to when an AVC bit stream comprises only one view. In some scenarios, e.g. when it is not expected that such high capabilities (or supported values of “level_idc”) are met by the targeted AVC decoders, it may be desirable to “thin out” the bit stream by discarding non-reference frames e.g. to meet the capability requirements of an old legacy decoder. By “non-reference frames” is meant “frames/pictures, which are not used as reference frame/picture for any other frame/picture”.

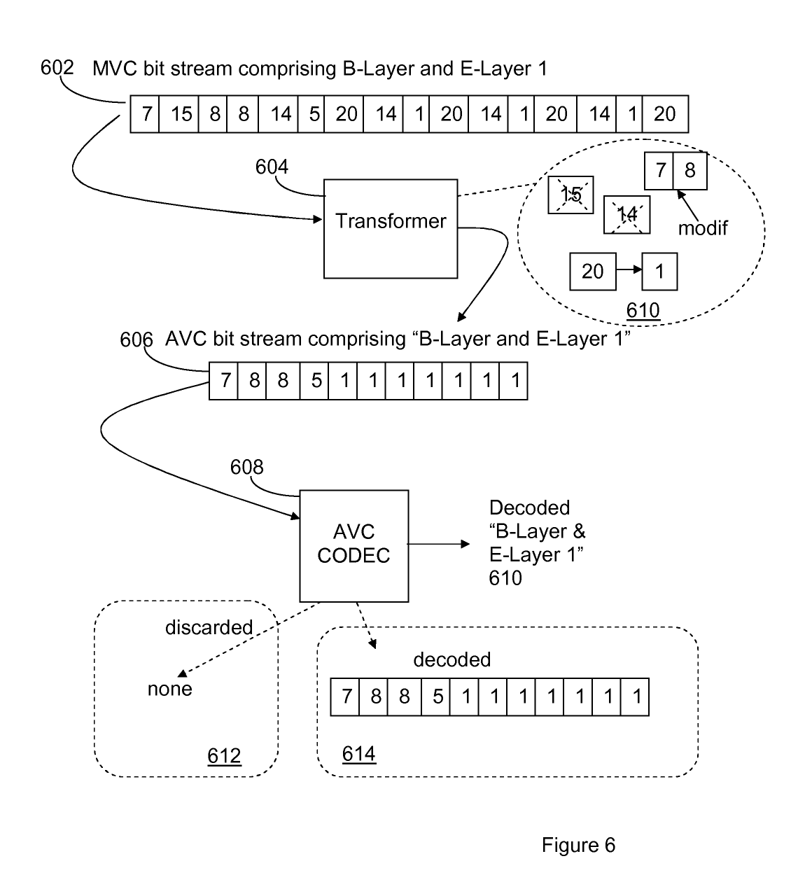

An exemplifying transformation and decoding procedure is illustrated in FIG. 6. The MVC bit stream 602 comprising base layer and a first enhancement layer, is fed into a transformer 604, in which modifications, as the ones previously described, are performed on the MVC bit stream. Examples of modifications performed in the transformer are illustrated in the area 610, having a dashed outline. The transformer 604 transforms the MVC bit stream into an AVC bit stream 606, which comprises the information from both the base layer and the first enhancement layer of the MVC bit stream. The AVC bit stream is input to an AVC decoder 608. Due to the modifications made in the transformer 604, the AVC decoder can now decode the AVC bit stream 606, and output the information which was comprised in the base layer and first enhancement layer of the MVC bit stream 602. Since the AVC bit stream 606 is adapted to an AVC decoder, no NAL units are discarded by the AVC decoder 608, which is illustrated in the area 612, having a dashed outline. Thus, all NAL units of the AVC bit stream 606 are decoded by the AVC decoder 608. The NAL units decoded by the AVC decoder 608 are illustrated in the area 612, having a dashed outline. This should be compared to the decoding illustrated in FIG. 4, where the same MVC bit stream as illustrated in FIG. 6 was input directly to the AVC decoder 404, without transformation.

Further, since an AVC decoder does not understand multiple POC syntax elements having the same value, the POC syntax elements could be changed to a sequential numerically consecutive order, in order to assure appropriate decoding and display of the bit stream.

When using the frame packing arrangement in AVC, the views may be multiplexed into the AVC bit stream in different ways. For example, two views, 0 and 1, may be interleaved e.g. as (view: 0,1; 0,1; 0,1; . . . ), or (view: 1,0; 1,0; 1,0; . . . ), or e.g. as (0,0; 1,1; 0,0; 1,1; . . . ). Typically, the first example, i.e. (view: 0,1; 0,1; 0,1; . . . ), corresponds to the order in which the different views or layers are interleaved in an MVC bit stream. Thus, when the multiplexing or interleaving of the different views corresponds between the MVC bit stream and the frame packing arrangement selected for the created AVC bit stream, the order of the NAL units in the bit stream does not need to be changed in the transformation from MVC to AVC for this reason. However, the interleaving order may differ between the MVC bit stream and a selected frame packing arrangement of the AVC bit stream, and under such circumstances, the order of the NAL units should be changed accordingly in the transformation.

### Reference Picture Management

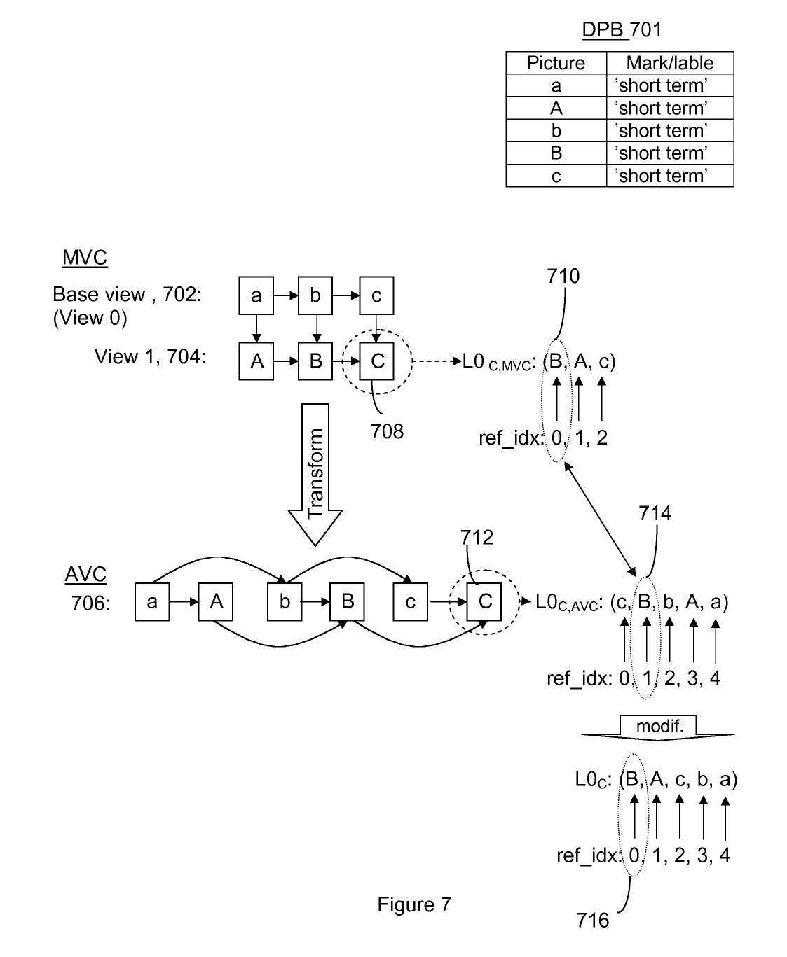

After completion of the above described modifications, the bit stream is technically decodable by use of an AVC decoder. However, the displaying of the outcome of the decoding may be corrupted, since the reference picture indexes are possibly leading to erroneous reference pictures. This reference picture index mismatch will be described below with reference to FIG. 7 To handle this mismatch, some reference picture commands may be inserted into the bit stream that explicitly signal the correct reference picture to be used.

In the AVC reconstruction process, which is part of the decoding process in an AVC decoder, all the reconstructed pictures are put in a Decoded Picture Buffer (DPB) provided with a mark or label. There are 3 types of marks basically indicating: ‘unused for reference’, ‘used for short term reference’ and ‘used for long term reference’. When constructing a reference picture list, the pictures marked as ‘short term’ are put first in the reference picture list in decreasing picture number order. The pictures marked as ‘Long term’ pictures come after the ‘short term’ pictures. When the ‘short term’ and ‘long term’ pictures are put into the list, the AVC reference picture list is completed. Basically the same procedure as described above for AVC is performed when constructing MVC reference picture lists. The difference when constructing MVC reference picture lists is that in addition to reference pictures in the current view, reference pictures in other views are added at the end of the list.

The construction of reference picture lists in MVC and AVC is illustrated in FIG. 7. For MVC, the reference picture index list L0_{C,MVC}, is constructed for the picture “C” 708 in view 1. Following the rules described above, the pictures in the DPB 701, which are associated with the same view as “C”, and marked ‘used for short term reference’, are put first in L0_{C,MVC}. In this example, this would be pictures “B” and “A”. Then, pictures in DPB 701 associated with the same view as “C”, and marked ‘used for long term reference’ should be put into L0_{C,MVC}. In this example, there are no such pictures. Then, since relating to MVC, pictures associated with other views, which pictures are aligned in time with “C”, i.e. should be presented at the same time as “C”, and are marked “short term”, should be added to L0_{C,MVC}, in this example “c”. Pictures “b” and “a” are not added to the reference picture list L0_{C,MVC} due to MVC constraints not allowing “diagonal prediction”. However, for other multiview coding schemes of similar type, which allow diagonal prediction, “b” and “a” may have been appended at the end of list. Thus, all pictures in the example DPB 701 are considered, and inserted into L0_{C,MVC}, which is then complete as L0_{C,MVC}=(B,A,c,b,a). When transforming the multi-layer MVC structure to a “single-layer” AVC structure, the reference picture list for the same picture “C” would look different if reconstructed for the AVC structure.

Since there is no view or layer-aspect in AVC, all pictures comprised in the DPB 701 could be seen as belonging to the same view or layer for AVC. Consequently, when constructing a reference picture list L0_{C,AVC} for the picture “C” 712 according to AVC rules, all pictures in DPB 701 marked ‘used for short term reference’ are to be put first in L0_{C}. In this case all pictures in DPB 701 are marked as ‘short term’, and L0_{C,AVC} will thus be constructed as L0_{C,AVC}=(c,B,b,A,a).

The previously mentioned reference picture index mismatch is here illustrated by the fact that the picture “B” will have a different reference picture index in the respective reference index lists L0_{C,MVC} and L0_{C,AVC}. For MVC, the picture “B” will have reference index “0”, which is encircled by a dotted line and marked 710 in FIG. 7. For AVC, the picture “B” will have reference index “1”, which is encircled by a dotted line and marked 712 in FIG. 7. The mismatch occurs, since picture “C”, when being encoded in an MVC encoder, is associated with the information that it should be decoded using the picture having reference index “0” (and “2”) in the reference picture list L0, i.e. L0_{C,MVC}. When an AVC decoder shall decode the encoded picture “C”, originally encoded by use of an MVC encoder, it will use the picture having reference index “0” in L0 (L0_{C,AVC}), in accordance with the information associated with “C”. However, since the reference picture indices in L0_{C,MVC} and L0_{C,AVC} point to different pictures, the AVC decoder will use the wrong reference picture(s) when decoding “C” 712, if this information mismatch is not handled appropriately.

The reference picture index mismatch problem could be solved by changing all reference index syntax elements from “0” to “1” for reference picture “B” in FIG. 7, and from “2” to “0” for reference picture “c”. However, this solution requires parsing and modification quite deep into the NAL unit(s), and may further involve changing in hundreds of places. It has now been realized that there are other, more efficient and less complex, solutions, which will be described below.

There are two types of commands specified in H.264/AVC that can affect reference picture lists. One is “Memory Management Control Operation” (MMCO) that can change the picture marking in the DPB, i.e. whether a picture is marked as ‘used for long term reference’, ‘used for short term reference’ or ‘unused for reference’. The change accomplished by use of MMCO is a permanent change that generally has impact also on the decoding of following pictures. The other command that can affect a reference picture list is “Reference Picture List Modification” (RPLM). The order of the reference pictures in a reference picture list can be changed to any desired order by use of the RPLM-command. It is realized that these commands could be inserted in the bit stream during the transformation from MVC bit stream to AVC bit stream.

Thus, a much better/simpler solution to the mismatch problem than the “change all occurrences of the reference index”-method described above, would e.g. be to modify the reference picture list on the decoder side (AVC) to mimic the reference picture list used when encoding e.g. the picture “B” at the encoder side (MVC).

There are different alternatives of how to perform such a modification or rearrangement of a reference picture list. Two such alternatives will be described below, still with reference to FIG. 7:
A ref_pic_list_modification command could be inserted in the picture slice header(s) of picture “B”. Such a command can explicitly signal or order a swap of positions in a reference picture list, such as L0_{C,AVC}, between e.g. entry 0 and entry 1, i.e. between the pictures having reference list index “0” and “1”. After “swapping” positions, the reference picture index “0” in L0_{C,AVC} will correspond to picture “B”. The ref_pic_list_modification command has only a temporary effect for the decoding of one picture. Afterwards, reference picture lists are constructed from DPB in a normal procedure.
An alternative would be to insert a dec_ref_pic_marking command in the picture “B” slice header (or in SEI message dec_ref_pic_marking_repetition), marking picture “c” as ‘used for long term reference’. Since ‘long term reference’ pictures are placed after ‘short term reference’ pictures when constructing a reference picture list, this would have the same effect as swapping of entry “0” and entry “1” as described above, i.e. the picture “B” would be placed in the first position of L0_{C,AVC}, and thus have reference picture list index “0”. L0_{C,AVC} could thus be adapted to “mimic” L0_{C,MVC} by the marking of pictures “c”, “b” and “a” as ‘used for long term prediction’.

The use of any of the alternatives above may provide, at the decoder side, an imitation of the reference picture list at the encoder side. However, the reference picture lists may not always correspond perfectly. For example, when encoding the picture “b”, there is actually only one reference picture (“a”) present in the reference picture list at the encoder side, but, when decoding the picture “b”, there are two reference pictures (“A” and “a”) present in the reference picture list. To make the reference picture lists for picture “b” equal at the encoder side and the decoder side, the picture “A” could be marked as ‘unused for reference’ to make it not being selected into the reference picture list L0_{b,AVC}. However, one drawback of this solution is that the dec_ref_pic_marking command in AVC can only change the marking of a picture from ‘used for reference’ to ‘unused for reference’ but not the other way around. Thus, once a picture has been marked as ‘unused for reference’ by use of this command, the picture will not appear in the reference picture list for any picture again. This irreversibility of the dec_ref_pic_marking command makes this method unsuitable for AVC, but this method can in principle apply to any other codec that can freely mark or unmark ‘unused for reference’.

When the reference picture list index mismatch problem has been solved e.g. using one of the above described methods, a converted bit stream can be correctly decoded by use of an AVC decoder.

In order to enable a player to correctly interpret the outcome of the AVC decoder in a stereo video scenario, a frame packing arrangement SEI message should be inserted into the modified bit stream. The frame packing arrangement SEI message may inform the player of the fact that a left view and a right view are temporally interleaved as even and odd frame, respectively. For the multi-view case involving more than 2 views, no such signaling exists in AVC today, and thus appropriate new signaling would have to be added. Until such signaling has been added to AVC, a transformer could e.g. remove all enhancement layers except the first one, thus reducing the transformed stream to stereo video. Alternatively, only the base layer and the first enhancement layer are modified into AVC format by a transformer unit, while additional enhancement layers are left unmodified by the transformer unit and will thus be maintained in MVC format. The enhancement layers which are maintained in MVC format will thus be discarded by an AVC decoder (cf. 408 in FIG. 4), and leave only stereo video to be decoded.

Alternatively, all enhancement views could be modified and decoded, and a functional unit could be provided in addition to the AVC decoder, which functional unit could be adapted to arrange the decoded pictures in the correct order for display.

### AVC to MVC

An MVC decoder will be able to decode an AVC bit stream due to the backwards compatible properties of MVC. However, an MVC decoder will not necessarily be capable of interpreting the AVC stereo signaling, such as the frame packing arrangement SEI message. Certain future set-top-boxes may, for example, be capable of decoding MVC stereo high profile, but not be able to interpret frame packing arrangement SEI message with temporal frame interleaving. In such a case, the operator could want to re-write the AVC stereo stream into an MVC stream, so that the set-top-boxes would be able to decode and interpret the stream. Another example could be the case where a stereo video is available in AVC frame packing arrangement SEI format, and someone wishes to store it on a 3D Blu-ray disc. Since 3D Blu-ray supports MVC stereo high profile, but not AVC frame packing arrangement SEI, a conversion from AVC to MVC could be helpful.

However, a conversion from AVC to MVC may not always be possible. Typically, the coding structure of an AVC bit stream would not support an AVC to MVC conversion. For example, when rearranging an AVC IPPP structure in which each P frame only references the immediate previous frame, which is the most typical AVC coding structure, with frame packing arrangement SEI message with temporal frame interleaving, to an MVC “layout” or structure, this MVC structure may comprise bi-directional prediction between layers and/or diagonal prediction. As previously mentioned, diagonal prediction is not supported or “allowed” in MVC. Further, only uni-directional prediction between layers is allowed. For example, base layer to 1st enhancement layer prediction is allowed, but not the other way around. Thus, an AVC bit stream which has a prediction structure, which when transformed into MVC layers would comprise non-appropriate prediction between the layers, cannot be successfully transformed into an MVC bit stream. Conversion of an MVC bit stream into an AVC bit stream does, however, not have any similar constraints.

Given it is possible to perform an AVC to MVC conversion, an exemplifying conversion of an AVC bit stream to an MVC bit stream could involve that view related info is derived from the AVC frame packing arrangement SEI message and converted into MVC NAL format. For example, each MVC layer should be assigned a view_id, and MVC NAL extensions should be created based on these view_ids, which extensions should be “prepended” to, i.e. added to the beginning of, each NAL unit. Further, prefix NAL units should be created and inserted in front of base layer NAL units; and Subset SPS should be created for the enhancement layers. Further, reference picture buffer management, similar as for MVC to AVC conversion, may be needed due to the problem of reference picture list index mismatch.

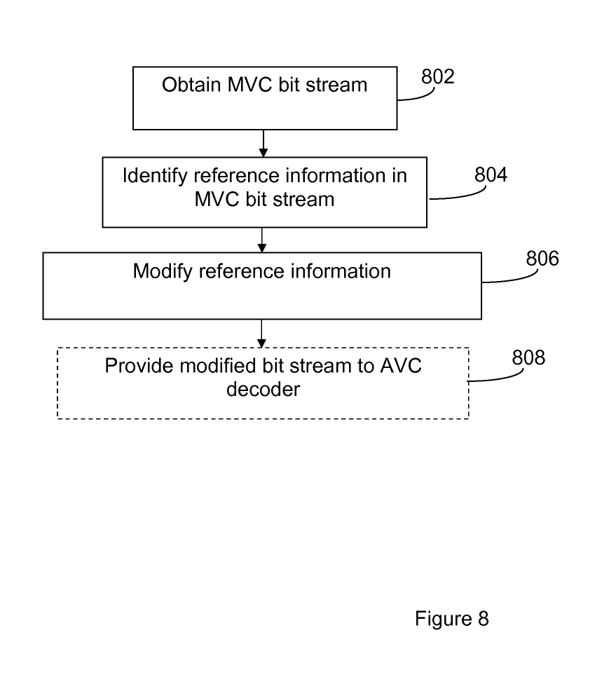

### Exemplifying Procedure, MVC to AVC, FIG. 8

An embodiment of the procedure of transforming an MVC bit stream into an AVC bit stream will now be described with reference to FIG. 8. The procedure could be performed in a video handling entity, which could be a video decoding entity, such as e.g. a set-top box, a computer or a mobile terminal, and/or, in a video encoding entity such as e.g. a server, a computer or a mobile terminal. Alternatively, the video handling entity could be an intermediate node between a video encoding entity and a video decoding entity.

Initially, an MVC bit stream comprising multiple views (or layers) is obtained in an action 802. The obtaining could involve e.g. receiving the bit stream from another node, or retrieving the bit stream from a storage unit, such as a memory or a Blu-ray disc. Then, reference information, e.g. slice header information and/or NAL unit header information, comprised in the MVC bit stream is identified in an action 804. Then, relevant reference information is modified in an action 806, such that the MVC bit stream is transformed or converted into an AVC bit stream also comprising multiple views, i.e. at least two views. The AVC bit stream could comprise all of, or a subset of, the views comprised in the MVC bit stream. The MVC reference information should be modified such that at least two of (all of, or a subset of) the views comprised in the resulting AVC bit stream could be decoded by use of an AVC decoder, and may further also be properly displayed after being decoded by the AVC decoder. The AVC bit stream may then be provided e.g. to an AVC decoder and/or to another video handling entity comprising an AVC decoder, in an optional action 808.

As previously described, examples of possible modifications, which may be performed when needed and/or desired, are e.g. changing the NAL unit type associated with at least one NAL unit related to at least one of the multiple views; removing NAL header MVC extension from NAL units related to at least one of the multiple views; changing the order of reference picture indicators in a reference picture list associated with at least one of the pictures in at least one of the multiple views; changing the order of appearance of NAL units in the bit stream; removing prefix NAL units; removing subset SPSs; changing the SPS to correspond to the AVC bit stream; changing the POC syntax element (in the slice header) to correspond to the order of appearance of the pictures from the different views in the AVC bit stream; adding AVC frame packing arrangement SEI messages and/or adding signaling regarding frame arrangement per view when the AVC bit stream represents or comprises more than two views.

Further, the modification of MVC reference information may involve changing the reference picture list index associated with a reference picture, e.g. by changing the order of the reference pictures in a reference picture list, or by changing all occurrences of a reference picture list index.

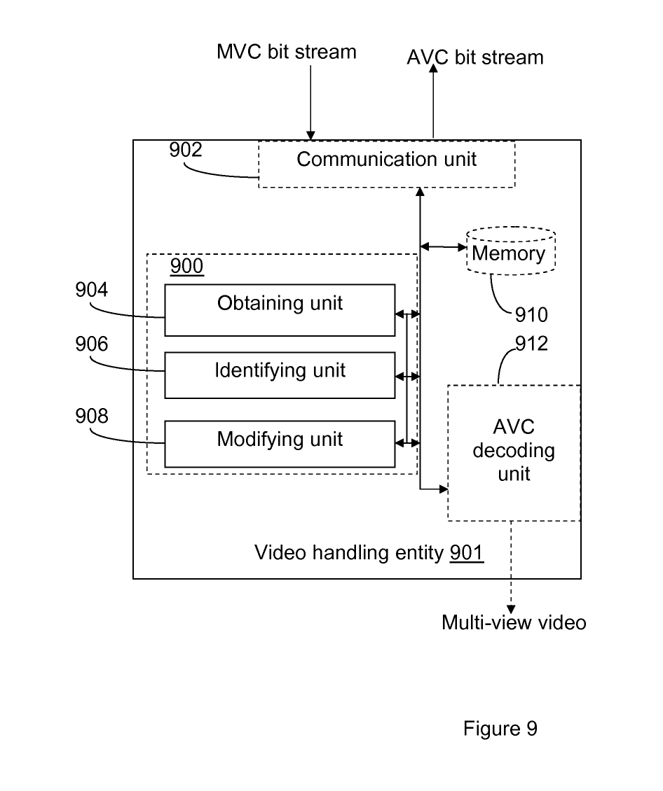

### Exemplifying Arrangement, MVC to AVC, FIG. 9

Below, an example arrangement 900, adapted to enable the performance of the above described procedure of converting an MVC bit stream into an AVC bit stream, will be described with reference to FIG. 9. The arrangement is illustrated as being located in a video handling entity, 901, which could be a video decoding entity, such as e.g. a set-top box, a computer or a mobile terminal, and/or, in a video encoding entity, such as e.g. a server, a computer or a mobile terminal. Alternatively, the video handling entity could be an intermediate node between a video encoding entity and a video decoding entity. The arrangement 900 is further illustrated to communicate with other entities via a communication unit 902, which may be considered to comprise conventional means for any type of wired and/or wireless communication.

The arrangement 900 comprises an obtaining unit 904, which is adapted to obtain an MVC bit stream, e.g. from the communication unit 902 or a storage unit, such as a memory 910. The arrangement 900 further comprises an identifying unit 906, which is adapted to identify reference information, such as e.g. slice header information, in the MVC bit stream. The arrangement further comprises a modifying unit 908, which is adapted to modify the reference information such that the MVC bit stream is transformed into an AVC bit stream also comprising multiple views, i.e. at least two views. The AVC bit stream could comprise all of, or a subset of, the views comprised in the MVC bit stream. The identified reference information may be adapted based e.g. on a predefined scheme or set of rules. The modifying unit 908 is adapted to modify the reference information such that at least two of (all of, or a subset of) the views in the AVC bit stream could be decoded by an AVC decoder. Examples of modifications which could be performed by the modifying unit 908 are listed above, in the description of the corresponding method with reference to FIG. 8.

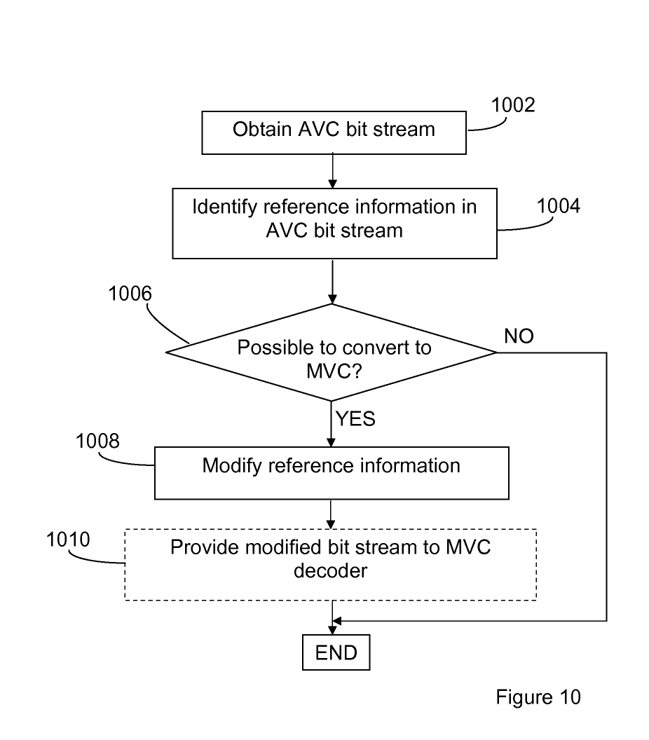

### Exemplifying Procedure, AVC to MVC, FIG. 10

An embodiment of the procedure of transforming an AVC bit stream into an MVC bit stream, i.e. the reverse of the procedure described above, will now be described with reference to FIG. 10. The procedure could be performed in a video handling entity, which could be a video decoding entity, such as e.g. a set-top box, a computer or a mobile terminal, and/or, in a video encoding entity such as e.g. a server, a computer or a mobile terminal. Alternatively, the video handling entity could be an intermediate node between a video encoding entity and a video decoding entity, such as e.g. a server.

Initially, an AVC bit stream comprising multiple views is obtained in an action 1002. The obtaining could involve e.g. receiving the bit stream from another node, or retrieving the bit stream from a storage unit, such as a memory. Then, reference information comprised in the AVC bit stream is identified in an action 1004. Then, it is determined, based on the obtained information, in an action 1006, whether the AVC stream is convertible to an MVC bit stream, e.g. with regard to the previously described restrictions on MVC inter-layer predictions. When the AVC bit stream is found to be convertible to an MVC bit stream, modification of the reference information is performed in an action 1008, such that the AVC bit stream is transformed or converted into an MVC bit stream also comprising multiple views, i.e. at least two views. The MVC bit stream could comprise all of, or a subset of, the views comprised in the AVC bit stream. The AVC reference information should be modified such that at least two (all of, or a subset of) of the views comprised in the resulting MVC bit stream could be decoded by use of an MVC decoder.

As previously described, examples of possible modifications, which may be performed when needed and/or desired, are e.g. changing the NAL unit type associated with at least one NAL unit related to at least one of the multiple views; adding NAL header MVC extension to NAL units related to at least one of the multiple views; changing the order of reference picture indicators in a reference picture list associated with at least one of the pictures in at least one of the multiple views; changing the order of appearance of NAL units in the bit stream; adding prefix NAL units to base layer; adding subset SPSs; changing the SPS to correspond to the MVC bit stream; changing the POC syntax element (in the slice header) to correspond to the order of appearance of the pictures from the different views in the MVC bit stream; removing AVC frame packing arrangement SEI messages and/or signaling regarding frame arrangement per view when the AVC bit stream represents or comprises more than two views.

The MVC bit stream may then be provided e.g. to an MVC decoder and/or to another video handling entity comprising an MVC decoder, in an optional action 1010.

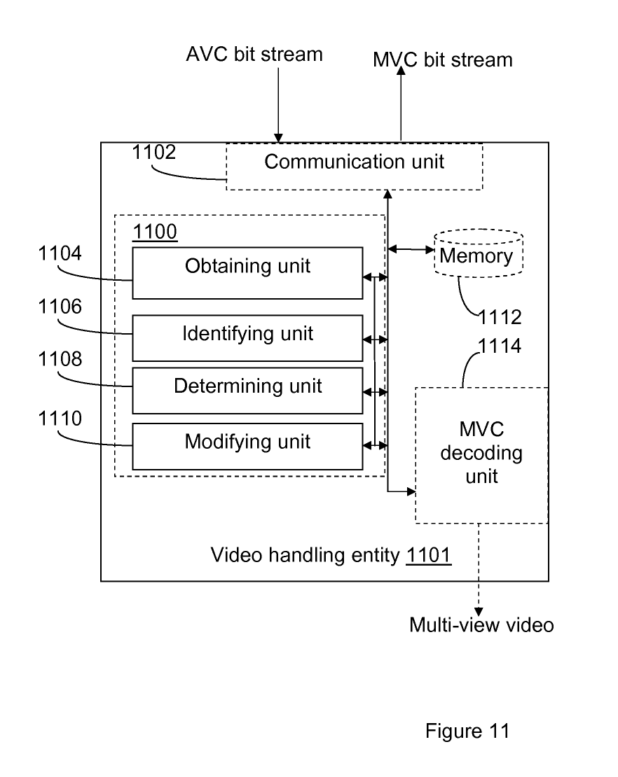

### Exemplifying Arrangement, AVC to MVC, FIG. 11

Below, an example arrangement 1100, adapted to enable the performance of the above described procedure of converting an AVC bit stream into an MVC bit stream, will be described with reference to FIG. 11. The arrangement is illustrated as being located in a video handling entity, 1101, which could be a video decoding entity, such as e.g. a set-top box, a computer or a mobile terminal, and/or, in a video encoding entity, such as e.g. a server, a computer or a mobile terminal. Alternatively, the video handling entity could be an intermediate node between a video encoding entity and a video decoding entity. The arrangement 1100 is further illustrated to communicate with other entities via a communication unit 1102, which may be considered to comprise conventional means for any type of wired and/or wireless communication.

The arrangement 1100 comprises an obtaining unit 1104, which is adapted to obtain an AVC bit stream, e.g. from the communication unit 1102 or a storage unit, such as a memory 1110. The arrangement 1100 further comprises an identifying unit 1106, which is adapted to identify reference information, such as e.g. slice header information, in the AVC bit stream. The arrangement further comprises a determining unit 1008, which is adapted to determine whether the prediction structure of the AVC bit stream can be applied to MVC, e.g. with regard to inter-layer prediction structure.

The arrangement 1100 further comprises a modifying unit 1110, which is adapted to modify the reference information such that the AVC bit stream is transformed into an MVC bit stream comprising multiple views (layers), i.e. at least two. The MVC bit stream could comprise all of, or a subset of, the views comprised in the AVC bit stream. The identified reference information may be adapted based e.g. on a predefined scheme or set of rules. The modifying unit 1110 is adapted to modify the reference information such that at least two of the views/layers in the MVC bit stream could be decoded by an MVC decoder, and further also be properly displayed after being decoded by the MVC decoder. Examples of modifications which could be performed by the modifying unit 1110 are listed above, in the description of the corresponding method with reference to FIG. 10.

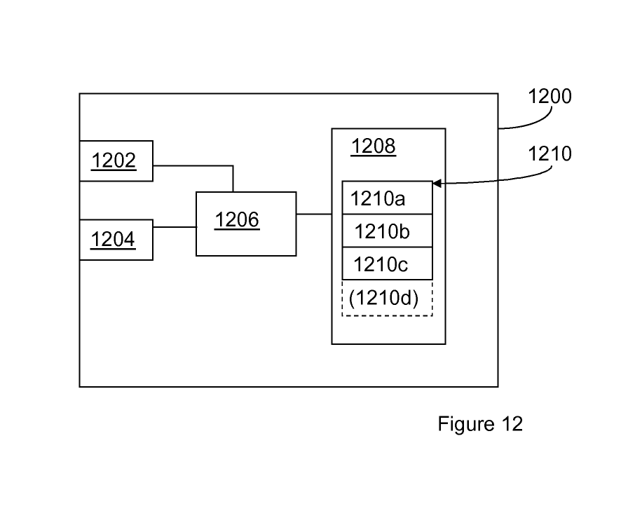

### Exemplifying Arrangement, FIG. 12

FIG. 12 schematically shows an embodiment of an arrangement 1200 in a video handling entity, which also can be an alternative way of disclosing an embodiment of the arrangement for transformation of an MVC bit stream into an AVC bit stream in a video handling entity illustrated in FIG. 9. Comprised in the arrangement 1200 are here a processing unit 1206, e.g. with a DSP (Digital Signal Processor). The processing unit 1206 can be a single unit or a plurality of units to perform different actions of procedures described herein. The arrangement 1200 may also comprise an input unit 1202 for receiving signals from other entities, and an output unit 1204 for providing signal(s) to other entities. The input unit 1202 and the output unit 1204 may be arranged as an integrated entity.

Furthermore, the arrangement 1200 comprises at least one computer program product 1208 in the form of a non-volatile memory, e.g. an EEPROM (Electrically Erasable Programmable Read-Only Memory), a flash memory and a hard drive. The computer program product 1208 comprises a computer program 1210, which comprises code means, which when executed in the processing unit 1206 in the arrangement 1200 causes the arrangement and/or the video handling entity to perform the actions of the procedure described earlier in conjunction with FIG. 8.

The computer program 1210 may be configured as a computer program code structured in computer program modules. Hence in the example embodiments described, the code means in the computer program 1210 of the arrangement 1200 comprises an obtaining module 1210a for obtaining an MVC bit stream, e.g., from a data transmitting entity or from a storage, e.g. a memory. The computer program further comprises an identifying module 1210b, for identifying reference information in the obtained MVC bit stream. The computer program further comprises a modifying module 1210c, for modifying the reference information, such that the MVC bit stream is transformed into an AVC bit stream, which may be decoded by an AVC decoder.

The modules 1210a-c could essentially perform the actions of the flow illustrated in FIG. 8, to emulate the arrangement in a video handling entity illustrated in FIG. 9. In other words, when the different modules 1210a-c are executed in the processing unit 1206, they could correspond to the units 902-908 of FIG. 9.

Similarly, a corresponding alternative to the arrangement for conversion of an AVC bit stream into an MVC bit stream, illustrated in FIG. 11, is possible. Such an arrangement would further comprise a determining module 1210d for determining whether an obtained AVC bit stream could be transformed into an MVC bit stream.

Although the code means in the embodiment disclosed above in conjunction with FIG. 12 are implemented as computer program modules which when executed in the processing unit causes the arrangement and/or video handling entity to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory e.g. for caching purposes. The computer program may be carried by a computer program product connected to the processor. The computer program product comprises a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the decoding entity.

While the procedures as suggested above have been described with reference to specific embodiments provided as examples, the description is generally only intended to illustrate the inventive concept and should not be taken as limiting the scope of the suggested methods and arrangements, which are defined by the appended claims. The methods and arrangements are described as relating to “AVC” and “MVC”. The terms “AVC” and “MVC” are considered to cover future versions, or “successors”, of these standards, such as e.g. HEVC, in which the concept and method of transformation is still relevant. While described in general terms, the methods and arrangements may be applicable e.g. for different types of communication systems, using commonly available communication technologies, such as e.g. GSM/EDGE, WCDMA or LTE or broadcast technologies over satellite, terrestrial, or cable e.g. DVB-S, DVB-T, or DVB-C, but also for storage/retrieval of video to/from memory.

It is also to be understood that the choice of interacting units or modules, as well as the naming of the units are only for exemplifying purpose, and video handling entities suitable to execute any of the methods described above may be configured in a plurality of alternative ways in order to be able to execute the suggested process actions.

It should also be noted that the units or modules described in this disclosure are to be regarded as logical entities and not with necessity as separate physical entities

### REFERENCES

[1] ITU-T Recommendation H.264 (03/09): “Advanced video coding for generic audiovisual services” |ISO/IEC 14496-10:2009: “Information technology—Coding of audio-visual objects—Part 10: Advanced Video Coding”.

### Abbreviations

### AVC Advanced Video Coding

### DPB Decoded Picture Buffer

### IDR Instantaneous Decoder Refresh

### MVC Multi-view Video Coding

### NAL Network Abstraction Layer

### NUT NAL Unit Type

### POC Picture Order Count

### PPS Picture Parameter Set

### SEI Supplemental Enhancement Information

### SPS Sequence Parameter Set

### STB Set Top Box

VCL Video Coding Layer

1-14. (canceled)

15. A method for transformation of a bit stream from Multi-view Video Coding (MVC) to Advanced Video Coding (AVC) in a video handling entity, the method comprising:
obtaining an MVC bit stream comprising multiple views;
identifying reference information in the MVC bit stream; and
modifying the reference information, such that the MVC bit stream is transformed into an AVC bit stream comprising multiple views, thereby enabling at least two of said views comprised in the AVC bit stream to be decoded by use of an AVC decoder, wherein said modifying the reference information comprises at least one of the following:
changing the order of reference picture indicators in a reference picture list associated with at least one of the pictures in at least one of the multiple views, and
changing the Picture Order Count (POC) syntax element in the slice header to correspond to the order of appearance of the pictures from the different views in the AVC bit stream.

16. The method of claim 15, wherein said modifying the reference information further comprises at least one of the following:
changing the Network Abstraction Layer (NAL) unit type associated with at least one NAL unit related to at least one of the multiple views;
removing NAL header MVC extension from NAL units related to at least one of the multiple views;
changing the order of appearance of NAL units in the bit stream;
removing prefix NAL units;
removing subset Sequence Parameter Set (SPSs);
changing the SPS to correspond to the AVC bit stream;
adding AVC frame packing arrangement Supplemental Enhancement Information (SEI) messages; and
adding signaling regarding frame arrangement per view when the AVC bit stream represents more than two views.

17. The method of claim 15, wherein said modifying the reference information comprises changing the reference picture list index associated with a reference picture.

18. The method of claim 17, wherein the changing of the reference picture list index associated with a reference picture comprises changing the order of the reference pictures in a reference picture list.

19. An apparatus in a video handling entity, the apparatus comprising:
an obtaining unit adapted to obtain an MVC bit stream comprising multiple views;
an identifying unit adapted to identify reference information in the obtained MVC bit stream; and
a modifying unit adapted to modify the reference information, such that the MVC bit stream is transformed into an AVC bit stream comprising multiple views by performing at least one of the following:
changing the Network Abstraction Layer (NAL) unit type associated with at least one NAL unit related to at least one of the multiple views, and
changing the Picture Order Count (POC) syntax element in the slice header to correspond to the order of appearance of the pictures from the different views in the AVC bit stream,
thereby enabling at least two of said views in the AVC bit stream to be decoded by use of an AVC decoder.

20. The apparatus of claim 19, wherein the modifying unit is further adapted to modify the reference information by performing at least one of the following:
changing the Network Abstraction Layer (NAL) unit type associated with at least one NAL unit related to at least one of the multiple views;
removing NAL header MVC extension from NAL units related to at least one of the multiple views;
changing the order of appearance of NAL units in the bit stream;
removing prefix NAL units;
removing subset Sequence Parameter Set (SPSs);
changing the SPS to correspond to the AVC bit stream;
adding AVC frame packing arrangement Supplemental Enhancement Information (SEI) messages; and
adding signaling regarding frame arrangement per view when the AVC bit stream represents more than two views.

21. The apparatus of claim 19, wherein the modifying unit is adapted to modify the reference information by changing the reference picture list index associated with a reference picture.

22. The apparatus of claim 21, wherein the modifying unit is adapted to change the reference picture list index associated with a reference picture by changing the order of the reference pictures in a reference picture list.

23. A method for reversed transformation of a bit stream from AVC to MVC in a video handling entity, the method comprising:
obtaining an AVC bit stream comprising multiple views;
identifying reference information in the AVC bit stream;
determining whether the prediction structure of the AVC bit stream can be applied to MVC; and,
when the prediction structure of the AVC bit stream can be applied to MVC, modifying the reference information, such that the AVC bit stream is transformed into an MVC bit stream comprising multiple views, thereby enabling at least two of said views comprised in the MVC bit stream to be decoded by use of an MVC decoder, wherein said modifying the reference information comprises at least one of the following:
changing the order of reference picture indicators in a reference picture list associated with at least one of the pictures in at least one of the multiple views, and
changing the Picture Order Count (POC) syntax element (in the slice header) to correspond to the order of appearance of the pictures from the different views in the MVC bit stream.

24. The method of claim 23, wherein modifying the reference information further comprises at least one of the following:
changing the NAL unit type associated with at least one Network Abstraction Layer (NAL) unit related to at least one of the multiple views;
adding NAL header MVC extension to NAL units related to at least one of the multiple views;
changing the reference picture list index associated with a reference picture,
changing the order of appearance of NAL units in the bit stream;
adding prefix NAL units to base layer;
adding subset Sequence Parameter Set (SPSs);
changing the SPS to correspond to the MVC bit stream; and
removing AVC frame packing arrangement Supplemental Enhancement Information (SEI) messages or signaling regarding frame arrangement per view, or both, when the AVC bit stream represents or comprises more than two views.

25. An apparatus adapted for reversed transformation of a bit stream from AVC to MVC in a video handling entity, the apparatus comprising:
an obtaining unit adapted to obtain an AVC bit stream comprising multiple views;
an identifying unit adapted to identify reference information in the obtained AVC bit stream;
a determining unit; adapted to determine whether the prediction structure of the AVC bit stream can be applied to MVC; and
a modifying unit adapted to, when the prediction structure of the AVC bit stream can be applied to MVC, modify the reference information, such that the AVC bit stream is transformed into an MVC bit stream comprising multiple views, by performing at least one of the following:
changing the order of reference picture indicators in a reference picture list associated with at least one of the pictures in at least one of the multiple views, and
changing the Picture Order Count (POC) syntax element in the slice header to correspond to the order of appearance of the pictures from the different views in the MVC bit stream;
thereby enabling at least two of said views comprised in the MVC bit stream to be decoded by use of an MVC decoder.

26. The apparatus of claim 25, wherein the modifying unit is further adapted to modify the reference information by performing at least one of the following:
changing the NAL unit type associated with at least one NAL unit related to at least one of the multiple views;
adding NAL header MVC extension to NAL units related to at least one of the multiple views;
changing the reference picture list index associated with a reference picture,
changing the order of appearance of NAL units in the bit stream;
adding prefix NAL units to base layer;
adding subset Sequence Parameter Set (SPSs);
changing the SPS to correspond to the MVC bit stream;
removing AVC frame packing arrangement Supplemental Enhancement Information (SEI) messages, or signaling regarding frame arrangement per view, or both, when the AVC bit stream represents or comprises more than two views.

27. A non-transitory computer-readable medium comprising a computer program stored thereupon, the computer program comprising computer-readable code that, when run in an apparatus in a video handling entity, causes the apparatus to:
obtain an MVC bit stream comprising multiple views;
identify reference information in the MVC bit stream; and
modify the reference information, such that the MVC bit stream is transformed into an AVC bit stream comprising multiple views, thereby enabling at least two of said views comprised in the AVC bit stream to be decoded by use of an AVC decoder, wherein said modifying the reference information comprises at least one of the following:
changing the order of reference picture indicators in a reference picture list associated with at least one of the pictures in at least one of the multiple views, and
changing the Picture Order Count (POC) syntax element in the slice header to correspond to the order of appearance of the pictures from the different views in the AVC bit stream.

28. A non-transitory computer-readable medium comprising a computer program stored thereupon, the computer program comprising computer-readable code that, when run in an apparatus in a video handling entity, causes the apparatus to:
obtain an AVC bit stream comprising multiple views;
identify reference information in the AVC bit stream;
determine whether the prediction structure of the AVC bit stream can be applied to MVC; and,
when the prediction structure of the AVC bit stream can be applied to MVC, modify the reference information, such that the AVC bit stream is transformed into an MVC bit stream comprising multiple views, thereby enabling at least two of said views comprised in the MVC bit stream to be decoded by use of an MVC decoder, wherein said modifying the reference information comprises at least one of the following:
changing the order of reference picture indicators in a reference picture list associated with at least one of the pictures in at least one of the multiple views, and
changing the Picture Order Count (POC) syntax element (in the slice header) to correspond to the order of appearance of the pictures from the different views in the MVC bit stream.
